(19) United States
(12) Patent Application Publication
(10) Pub. No.: US 2003/0194223 A1
(43) Pub. Date: Oct. 16, 2003

(54) Reproducing apparatus for a recording medium that stores compressed data, such as audio, video or audio/video data, therein, and a controlling method thereof

(76) Inventor: Yong-Ho Kim, Suwon-City (KR)

Correspondence Address: Joseph J. Buczynski, Roylance, Abrams, Berdo & Goodman, L.L.P., Suite 600, 1300 19th Street, Washington, DC, 20036, US

(21) Appl. No.: 10/373,734

(22) Filed: Feb. 27, 2003

(30) Foreign Application Priority Data
Apr. 11, 2002 (KR) 2002-19614

(51) Int. Cl. H04N 5/781

(52) U.S. Cl. 386/111; 386/125

(57) ABSTRACT

A reproducing apparatus for a recording medium that records compressed data, such as audio, video, or audio/video data, therein and a controlling method for controlling operation of the recording apparatus. An output signal of a broadcasting receiving unit and VCR reproducing signal is output while compressed data is being decoded in reproducing mode, and as the decoding is completed, a signal such as an audio, video, or audio/video (A/V) signal, of decoded data is output so that a user can instead watch broadcasting program or VCR reproducing screen without having to change the mode while the data of the recording medium is decoded.

This application claims benefit under 35 U.S.C. § 119 from Korean Patent Application No. 2002-19614, filed on Apr. 11, 2002, the entire content of which is incorporated herein by reference.

### BACKGROUND OF THE INVENTION

1. Field of the Invention

The present invention generally relates to a reproducing apparatus for a recording medium that stores compressed data, such as audio, video, or audio/video data, therein, and a controlling method thereof. More particularly, the present invention relates to a reproducing apparatus for a recording medium, such as a digital video disk (DVD), that stores compressed data therein, which allows a broadcasting screen or a video cassette recorder (VCR) reproducing screen to be output during a decoding of the compressed data in a reproducing mode of the recording medium, and a method for controlling the reproducing apparatus.

2. Description of the Related Art

As known in the art, the term DVD refers to a digital video disk or a digital versatile disk, which is an image medium capable of recording a motion picture with high quality. Image data recorded on a DVD is compressed with an MPEG method that is an international standard method. A DVD player is an apparatus for decoding compressed image data recorded on the DVD, converting the data into an analog signal and outputting the image data. AVCR is an apparatus for recording a signal and, in particular, an audio/video signal, on a magnetic tape, or reproducing such audio/video signal recorded on the magnetic tape.

A combination system developed to perform the function of the DVD and the VCR together is called a DVD/VCR combination system or a DVD/VCR combo system.

FIG. 1 is a view schematically showing the DVD/VCR combo system and peripheral devices connected with the combo system. The DVD/VCR combo system 10 has a VCR unit 11 to perform general functions of a VCR, and a DVD unit 12 to perform general functions of DVD to reproduce image and sound recorded on the DVD.

In addition to functioning as the VCR unit 11 and the DVD unit 12, the DVD/VCR combo system 10 also has an advantage of being capable of recording the image and the sound reproduced at the DVD unit 12 on a magnetic tape at the VCR unit 11.

A television (TV) 23 can be connected with the DVD/VCR combo system 10 as a peripheral device for outputting the image and the sound reproduced at the DVD unit 12 and the VCR unit 11 mounted therein. Moreover, an audio amp 21 can be connected as a peripheral device for outputting the sound reproduced at the DVD 12, and an external apparatus 25, such as a camcorder, can be connected to the DVD/VCR combo system 10. The DVD/VCR combo system 10 records and reproduces the image and the sound with the sound and the image transmitted from the external apparatus 25.

The VCR unit 11 and the DVD unit 12 are configured as one system in a single casing in the DVD/VCR combo system 10. A user can manipulate the functions of each device 11 and 12 and the mode conversion between the VCR unit 11 and the DVD unit 12 by manipulating a manipulation panel (not shown) disposed at the front of the DVD/VCR combo system 10, or via a separate input device such as a remote controller 15.

The combo system 10 can reproduce the image data recorded on the videotape or an optical disk, and the combo system with a broadcasting signal receiving function allows viewers to watch broadcast programs by outputting the broadcasting signal transmitted through a broadcasting receiving unit (not shown), such as a tuner disposed in the combo system 10.

To reproduce the image data recorded on the magnetic tape at the above-described combo system 10, the VCR reproducing is performed after the mode of the combo system is switched to a VCR reproducing mode. To reproduce the DVD, DVD reproducing is performed after the mode of the combo system 10 is switched to a DVD reproducing mode. When reproducing the VCR, only the analog signal processing is required. Thus, there is not much time required to output a reproducing screen, even if the VCR is activated from a stop status.

However, when reproducing the DVD, since the image data is recorded on the disk in the compressed digital form, time is required for error correction and recovery. Further, since the compressed data also requires data decoding, and since the decoded digital data is required to be converted to the analog image signal, the user has to wait for many seconds after inputting a reproducing command until he or she can finally watch the normal screen. Usually, a logo screen stored in the memory is shown until DVD is reproduced, but the screen is simple and thus is tedious to view.

FIG. 2 shows an example of a procedure of the operation of the conventional DVD/VCR combo system in the DVD mode. As shown in FIG. 2, as the DVD reproducing mode is on and the DVD is accordingly loaded in step S10, the compressed data recorded on the DVD is decoded and converted into the analog signal (in step S20. The A/V signal of the decoded data is output through the TV 23 or the audio amp 21 in step S31). While the compressed data is being decoded, the logo screen is displayed on the screen in step S21, or a blue screen is displayed.

Therefore, in the reproducing of the DVD, the user waits tediously, watching the logo screen or the blue screen while the data is being decoded, or watches another screen by converting to the VCR mode or to the broadcasting mode, and then inputs the mode conversion key for the DVD mode again when the data is completely decoded.

### SUMMARY OF THE INVENTION

The embodiments of the present invention have been made to overcome the above-mentioned problems. Accordingly, it is an object of the present invention to provide a reproducing apparatus for reproducing compressed data, such as audio, video or audio/video data, which enables a user, who has input a reproducing command to reproduce compressed data from a recording medium such as a DVD, to instead watch other types of screens, such as a broadcasting screen, when he or she is waiting for the compressed data to be decoded for actual image signals to be output, so that the user can wait without being bored until the DVD A/V signals are successfully output.

The above object, and other objects, are substantially accomplished by a reproducing apparatus for a recording medium that stores compressed data, such as audio, video or audio/video data, therein according to an embodiment of the present invention. The reproducing apparatus includes a decoding unit to decode the compressed data stored in the recording medium, a broadcasting receiving unit to receive a broadcast signal, and a controller to control the reproducing apparatus so that when the recording medium is loaded, an output signal of the broadcasting receiving unit is output while the decoding unit decodes an initial portion of the data of the recording medium, thereby enabling a user to watch a broadcast program while the compressed data is being decoded.

The controller controls such that the decoded data is output when the data decoding of the recording medium is completed. Accordingly, the user's convenience increases because without having to switch the mode, the user can have the output of the broadcasting signals during the data decoding, and then the output of the audio, video, or audio/video signals of the fully decoded data automatically output upon completion of the data decoding. Furthermore, the controlling unit can control such that one selected among the broadcasting signal and the VCR output signal is output during the decoding of the initial portion of the data, that is, while the recording medium is loading.

According to an embodiment of the present invention, a controlling method of a reproducing apparatus for a recording medium that stores compressed data, such as audio, video, or audio/video data, therein, and having a broadcast signal reception function, includes the steps of a) decoding the compressed data of the recording medium, b) allowing a user to view the broadcast signal while an initial portion of the compressed data of the recording medium is being decoded, and c) outputting the decoded compressed data, which includes an audio, video, or audio/video signal, when the decoding of the initial portion of the compressed data of the recording medium is completed.

### BRIEF DESCRIPTION OF THE DRAWINGS

The above-mentioned objects and the feature of the present invention will be more apparent by describing the preferred embodiment of the present invention by referring to the appended drawings, in which:

FIG. 1 is a block diagram schematically showing a conventional DVD/VCR combo system;

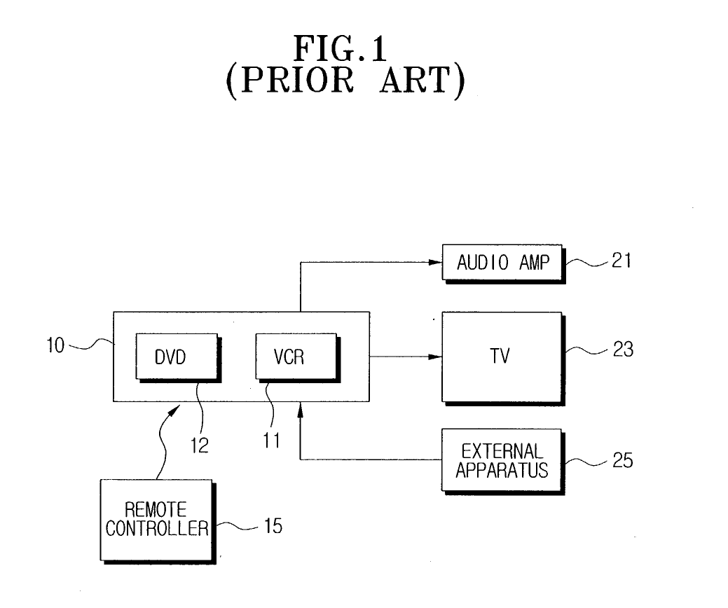

FIG. 2 is a flow chart schematically showing a controlling method in a DVD reproducing mode of the conventional DVD/VCR combo system;

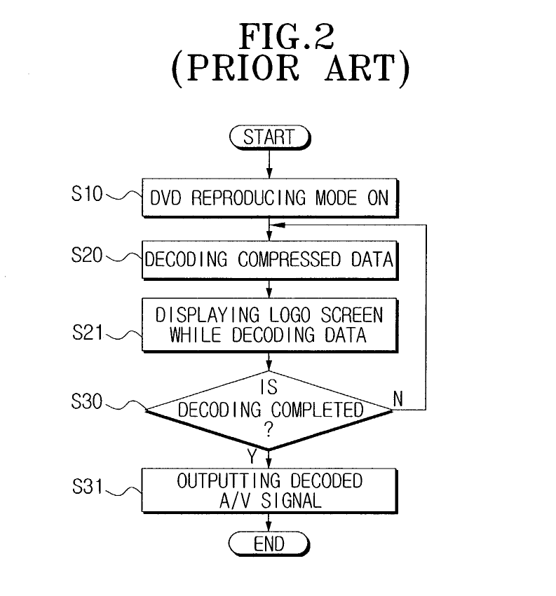

FIG. 3 is a block diagram schematically showing components of a DVD/VCR combo system according to an embodiment of the present invention;

FIG. 4 is a block diagram showing the inside structure of the DVD/VCR combo system according to an embodiment of the present invention; and

FIG. 5 is a flow chart showing a controlling method of the DVD/VCR combo system according to an embodiment of the present invention.

### DETAILED DESCRIPTION OF THE PREFERRED EMBODIMENTS

Certain embodiments of the present invention will be described in greater detail below by referring to the appended drawings.

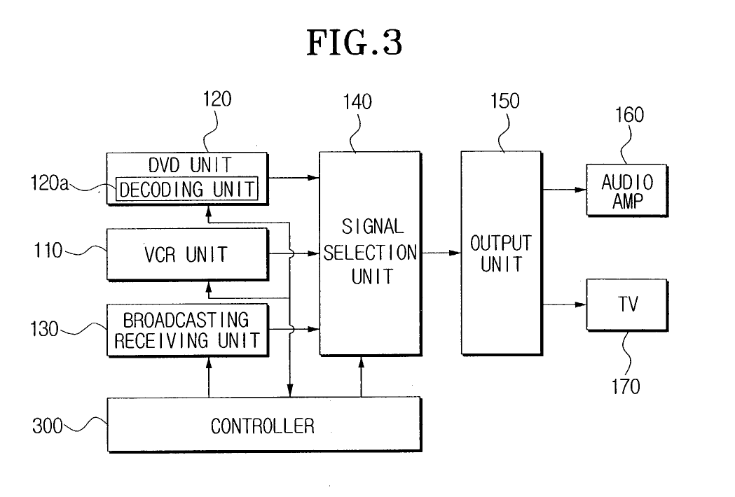

FIG. 3 is a view schematically showing an example of the structure of a combo system applying a reproducing apparatus for reproducing compressed data, such as audio, video, or audio/video data. As shown in FIG. 3, the combo system according to an embodiment of the present invention includes a controller 300, a DVD unit 120, a decoding unit 120a, a VCR unit 110, a broadcasting receiving unit 130, a signal selection unit 140 and an output unit 150. The reference numeral 160 is an audio amp to output an audio signal, and 170 is a TV.

The controller 300 outputs a controlling signal to control each component of the combo system. Either a DVD controlling unit to control the DVD unit 120 or a VCR controlling unit to control the VCR unit 110 can play the role of the host controller, or a controlling unit can be disposed as a separate host. The DVD unit 120 decodes the stored data to reproduce the DVD and outputs decoded A/V signal. The stored data is decoded by the decoding unit 120a. The VCR unit 110 outputs the image and the sound signal stored on a magnetic tape. The broadcasting receiving unit 130 outputs a broadcasting signal after receiving the signal input from an outside source. The signal selection unit 140 selects a signal to be output in accordance with the controlling signal of the controller 300 among signals output from the DVD unit 120, the VCR unit 110 and/or the broadcasting receiving unit 130, and sends the selected signal to the output unit 150. The output unit 150 outputs the transmitted signal to the audio amp 160 or the TV 170 after converting the signal into the audio, video, or audio/video signal, as appropriate.

The controller 300 according to an embodiment of the present invention controls the signal selection unit 140 in order to output one of the output signal of the broadcasting receiving unit 130 or the VCR unit 110 when it is determined that the DVD is being decoded in the DVD reproducing mode. When a decoding completion signal is input, the controller 300 controls the signal selection unit 140 in order to output the decoded DVD signal.

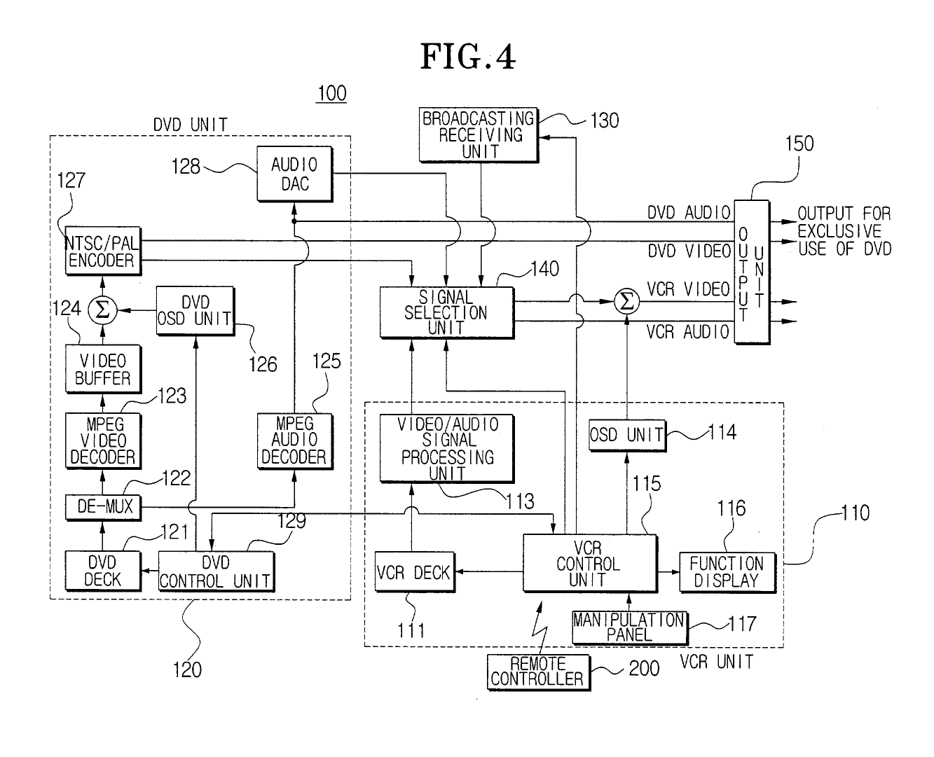

The DVD/VCR combo system according to an embodiment of the present invention will be described in greater detail by referring to FIG. 4 below. FIG. 4 is a block diagram showing an example of the inside structure of the DVD/VCR combo system capable of performing the function of the DVD and the VCR and the broadcasting receiving. In the combo system of FIG. 4, the VCR controlling unit 115 of the VCR unit 110 is the controller 300 that is the host shown in FIG. 3.

According to FIG. 4, the DVD/VCR combo system 100 has a VCR unit 110 to perform the general function of the VCR, a DVD unit 120 to perform the general function of the DVD, and a broadcasting receiving unit 130 to receive the broadcasting signal, a signal selection unit 140 to perform the selection with respect to the signals output from the VCR unit 110, the DVD unit 120 and the broadcasting receiving unit 130. The DVD/VCR combo system 100 further includes an output unit 150 to provide the signal output from the VCR unit 110 and the DVD unit 120 to the peripheral devices such as the TV or the amp, and an OSD unit 114 to add the OSD (on-screen display) function to the image signal output from the VCR unit 110 and the DVD unit 120.

The VCR unit 110 includes a VCR deck 111 to reproduce the signal recorded on the magnetic tape or record the signal on the magnetic tape, a video/audio signal processing unit 113 to process the video and the audio signal to be recorded or reproduced in relation to the VCR deck 111, and the VCR controlling unit 115 to control the entire operation of the VCR deck 111 and the video/audio signal processing unit 113. The VCR controlling unit 115 according to an embodiment of the present invention is the host controller to control the entire combo system, and the VCR controlling unit 115 outputs the controlling signal to the signal selection unit 140, the broadcasting receiving unit 130 and a DVD controlling unit 129. A function display unit 116 displays the status such as the operation, controlling, and mode of the system to the outside so that the user can know the current status of the system. A key input unit 117 is input various commands from the user. The function display unit 116 generally uses an LCD, an FLT or an LED.

The DVD unit 120 includes a DVD controlling unit 129, a DVD deck 121, a DE-MUX (DE-multiplex) 122, an MPEG video decoder 123, a DVD OSD unit 126, an NTSC/PAL encoder 127, an MPEG audio decoder 125 and an audio DAC (D/A converter) 128. All the parts of the DVD unit 120 are formed as one chip except for the DVD controlling unit 129 and the DVD deck 121.

The DVD deck 121 reads the data recorded on the DVD in order to perform the reproducing operation with respect to the DVD. The DE-MUX 122 divides digital data output from the DVD deck 121 into the video data and the audio data. The MPEG video decoder 123 decodes compressed video data into original digital video data, and a video buffer 124 stores certain amount of the video data. The video buffer 124 usually stores the video data for constructing the screen of one frame.

The MPEG video decoder 123 receives the data read by the DVD deck 121 and decodes the data. After that, the MPEG video decoder 123 sends the information to the DVD controlling unit 129 as to whether the decoding of the video data required for constructing one frame is completed or not. The information on the decoding completion of the video data required for constructing one frame can be output from the video buffer 124. The DVD controlling unit 129 controls the output of the DVD A/V signal until the MPEG video decoder 123 decodes the data for outputting a successful screen.

The signal selection unit 140 receives the signals output from the NTSC/PAL encoder 127, the audio DAC 128, the broadcasting receiving unit 130 and the video/audio signal processing unit 113. The signal selection unit 140 performs selection operation with respect to the input signals under the control of the VCR controlling unit 114. Moreover, the signal selection unit 140 outputs to the OSD unit 114 and the output unit 150 the signal input by the request of the user, such as a request for reproducing of DVD, reproducing and recording of the video tape, and outputting of the broadcasting signal.

The output unit 150 generates the DVD A/V signal, a super or component video signal, an analog audio signal, and a composite video signal. Among them, the digital audio and the super signal or the component signal are exclusively output for the DVD, and thus, they are separate from the analog output signals, that is, the composite video signal and the analog audio signal. Peripheral devices such as the TV or the audio amp are connected to the output unit 150, and accordingly, the image and the sound are output from the peripheral devices.

Furthermore, the combo system 100 according to an embodiment of the present invention has the broadcasting receiving unit 130 to receive the broadcasting signal from an antenna and output the image signal via a certain channel. The broadcasting receiving unit 130 has an electric wave receiving component, such as the antenna, installed at the combo system 100, and a synchronization unit to extract a signal of a certain channel from the broadcasting signals received through the electric wave receiving device. The broadcasting signal received through the broadcasting receiving unit 130 is input into the signal selection unit 140, and the signal selection unit 140 outputs the received broadcasting signal to the TV or the amp based on the selection of the user.

In the above-described embodiments, the VCR controlling unit 115 is the host controller, thus the DVD controlling unit 129 cannot directly control the signal selection unit 140, and when the information on the current status is sent to the VCR controlling unit 115, the VCR controlling unit 115 controls the signal selection unit 140. At this time, the DVD controlling unit 129 can directly control the signal selection unit 140. In addition, FIG. 4 shows the means for inputting data, such as remote controlling sensor or the manipulation panel 117 being disposed only at the VCR unit 110 according to an embodiment of the present invention. Therefore, when the user inputs the data related to the DVD, the data is transmitted to the DVD controlling unit 129 by the VCR controlling unit 115. Moreover, the DVD controlling unit 129 and the VCR controlling unit 115 have the function of transmission each other so that the data input by the user can be commonly used by the DVD unit 120 and the VCR unit 110.

An example of a controlling method of the reproducing apparatus of the recording medium having the recorded compressed data, such as audio, video, or audio/video data, will be described by referring to FIGS. 3-5.

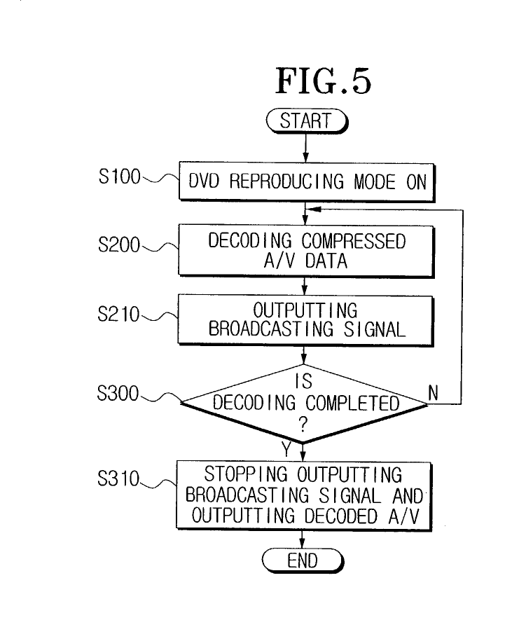

As shown in FIG. 5, the DVD is loaded on the DVD deck 121, and the user selects the DVD reproducing mode by manipulating the key input unit 117, then the controlling of the DVD reproducing mode is started as the DVD reproducing mode on signal is input into the DVD controlling unit 129 from the VCR controlling unit 115 in step S100. When the DVD reproducing mode is on, the data compressed on the DVD is decoded at the decoding unit 120a, and the decoded video signal is stored at the video buffer 124 in step S200. The VCR controlling unit 115 controls the signal selection unit 140 so that the broadcasting signal is output based on the data decoding signal of the DVD unit 120 in step S210. The VCR controlling unit 115 can allow the VCR reproducing signal to be output instead of the broadcasting signal. Therefore, while the data of the DVD is being decoded, the user can watch the output broadcasting program or the VCR reproducing signal instead of waiting tediously watching the logo screen or the blue screen.

In other words, the DVD controlling unit 129 transmits the command to the VCR controlling unit 115 not to output the DVD signal until the data for constructing the screen of one frame is decoded, and the VCR controlling unit 115 controls the signal selection unit 150 so that the output signal of the VCR unit 110 or the output signal of the broadcasting receiving unit 130 can be output to the output unit 150 instead of the DVD output signal. When the data for constructing the screen of one frame is decoded, the signal indicating the decoding completion is input from the MPEG video decoder 123 or the video buffer 124 to the DVD controlling unit 129, and the DVD controlling unit 129 transmits the signal to the VCR controlling unit 115 indicating that the DVD output signal is ready. When it is determined that the data is completely decoded in step S300, the VCR controlling unit 115 controls the signal selection unit 140 so that the decoded DVD signal can be output in step S310.

Therefore, in the DVD reproducing mode, the user can watch the broadcasting screen or the VCR reproducing screen during the decoding of the DVD without having to change to the broadcasting mode or to the VCR reproducing mode. Then, when the decoding is completed, the user can watch the DVD reproducing screen.

According to the embodiments of the present invention described above, as the user can watch the broadcasting screen output from the broadcasting receiving unit or the VCR reproducing screen until the compressed image data is decoded and a normal video signal is obtained without changing the mode when the image data recorded on the optical disk is reproduced, the tediousness of watching the logo screen stored at the memory is reduced, and also, the memory for storing the logo screen is not required.

Although certain embodiments of the present invention have been described, it will be understood by those skilled in the art that the present invention should not be limited to the described embodiments, but various changes and modifications can be made within the spirit and the scope of the present invention. Accordingly, the scope of the present invention is not limited within the described range but the following claims.

What is claimed is:

1. An apparatus for a recording medium that stores compressed data therein, the apparatus comprising:
a decoding unit, adapted to decode the compressed data stored in the recording medium;
a broadcasting receiving unit, adapted to receive a broadcast signal; and
a controller, adapted to control said broadcast receiving unit to output a received broadcast signal when the recording medium is loaded and while said decoding unit decodes an initial portion of the data of the recording medium, to enable a user to watch a broadcast program while the initial portion of the compressed data is being decoded.

2. An apparatus as claimed in claim 1, wherein:
said compressed data includes at least one of audio data and video data.

3. An apparatus as claimed in claim 1, wherein:
said controller is further adapted to control said decoding unit to output decoded data when the initial portion of the data decoding of the recording medium is completed.

4. An apparatus as claimed in claim 3, wherein:
said decoded data includes at least one of audio data and video data.

5. An apparatus as claimed in claim 1, further comprising:
a signal selection unit, adapted to receive said received broadcast signal output from said broadcast receiving unit and a video cassette recorder (VCR) output signal from a VCR; and
wherein said controller is further adapted to control said signal selection unit to output one of said received broadcast signal and said VCR output signal based on a selection by said user, to enable said user to watch said broadcast program or a VCR program, as desired, while said decoding unit is decoding the initial portion of the compressed data.

6. An apparatus as claimed in claim 1, further comprising:
a signal selection unit, adapted to receive said received broadcast signal output from said broadcast receiving unit, a video cassette recorder (VCR) output signal from a VCR and said decoded data output from said decoding unit; and
wherein said controller is further adapted to control said signal selection unit to output one of said received broadcast signal, said VCR output signal and said decoded data based on a selection by said user, to enable said user to watch said broadcast program, a VCR program, or a DVD program, as desired.

7. An apparatus as claimed in claim 1, further comprising:
a remote control, adapted for use by said user to control said selection unit to output one of said received broadcast signal, said VCR output signal and said decoded data.

8. A method for controlling a reproducing apparatus for a recording medium that stores compressed data therein, the method comprising:
decoding the compressed data of the recording medium; and
allowing a user to view a received broadcast signal while an initial portion of the compressed data of the recording medium is being decoded.

9. A method as claimed in claim 8, wherein:
said compressed data includes at least one of audio data and video data.

10. A method as claimed in claim 8, further comprising:
outputting a decoded signal when the decoding of said initial portion of the compressed data of the recording medium is completed, to enable said user to select said decoded signal for viewing.

11. A method as claimed in claim 10, wherein:
said decoded signal includes at least one of audio data and video data.

12. A method as claimed in claim 10, further comprising:
selecting, based on a command provided by said user, one of said received broadcast signal and said decoded data, for viewing.

13. A method as claimed in claim 8, further comprising:
outputting a video cassette recorder (VCR) output signal to enable said user to select said VCR output signal for viewing while the initial portion of the compressed data is being decoded.

14. A method as claimed in claim 13, further comprising:
selecting, based on a command provided by said user, one of said received broadcast signal, said VCR output signal and said decoded data, for viewing.
